(19) United States
(12) Patent Application Publication
(10) Pub. No.: US 2004/0153332 A1
(43) Pub. Date: Aug. 5, 2004

(54) Printed materials procurement system

(75) Inventors: Noli Libuit, Los Altos Hills, CA (US); Robert R. Axenfeld, West Chester, PA (US)

Correspondence Address: SYNNESTVEDT & LECHNER, LLP, 2600 ARAMARK TOWER, 1101 MARKET STREET, PHILADELPHIA, PA, 191072950

(73) Assignee: The Regal Press, Inc., Norwood, MA

(21) Appl. No.: 10/424,499

(22) Filed: Apr. 25, 2003

Related U.S. Application Data
(60) Provisional application No. 60/375,685, filed on Apr. 26, 2002.

(51) Int. Cl. G06F 17/60

(52) U.S. Cl. 705/1; 705/26

(57) ABSTRACT

An improved system and method for procuring printed materials over a network, e.g., the Internet is described. In one implementation, a print material procurement system includes software configured to: receive profile information from a particular customer. And in response to the profile information and without any user intervention, automatically: serve, to a client computer, a Web browser page with a graphical image of printed material particularly associated with the customer. The Web browser page contains icons permitting a user of the client computer to view, proof and/or order one or more types of printed material with one or more portions of the profile information displayed as part of the graphical image of the printed material. This abstract itself is not intended to limit the scope of this patent. The scope of the present invention is pointed out in the appending claims.

### CROSS-REFERENCE TO RELATED APPLICATIONS

This application claims priority from U.S. Provisional Patent Application Serial No. 60/375,685, entitled Printed Materials Procurement System, filed on Apr. 26, 2002, which is incorporated herein its entirety.

### TECHNICAL FIELD

The present invention relates to computer software systems and, more particularly, to systems for procuring printed materials.

### BACKGROUND

Procurement systems are being developed that utilize the World Wide Web (Web) to allow purchasers to order printed materials. Typically, a purchaser accesses these systems over the Web using a Web browser (browser). These procurement systems generate Web pages (pages) that are transferred over the Web and viewed by the purchaser on the browser running on the purchaser's computer. These procurement systems suffer from three main limitations. First, they are inefficient; second, they are incompatible with many business-to-business (B2B) purchasing systems; and third, they do not completely automate the procurement of printed materials.

Existing procurement systems are inefficient in terms of order entry and review. Order entry and review is hampered by inefficiently designed pages that require numerous pages (typically eight or more) to be viewed by the purchaser to place an order. In addition, orders are not summarized in a manner that can be quickly reviewed for confirmation by the purchaser. Existing procurement systems are also incompatible with many B2B purchasing systems because they are not adapted for use with any B2B purchasing system or they are specifically designed for use with one specific B2B purchasing system. Many companies have adopted Web-enabled B2B purchasing systems offered by such companies as Ariba, Clarus, Commerce. Since companies preferably use their selected B2B purchasing systems for making purchases, they are unlikely to procure printed material from procurement systems that are incompatible with their existing B2B purchasing systems. Accordingly, sales may be lost if a procurement system is incompatible with the B2B purchasing system of a company. Existing procurement systems also are not completely automated to include order processing, typesetting, proofing, and imposition of printed materials for printing, and remain labor-intensive and costly.

### SUMMARY

An improved system and method for procuring printed materials over a network, e.g., the Internet is described. In one implementation, a print material procurement system includes software configured to: receive profile information from a particular customer. And in response to the profile information and without any user intervention, automatically: serve, to a client computer, a Web browser page with a graphical image of printed material particularly associated with the customer. The Web browser page contains icons permitting a user of the client computer to view, proof and/or order one or more types of printed material with one or more portions of the profile information displayed as part of the graphical image of the printed material.

The aforementioned problems are, therefore, overcome by allowing a buyer to enter orders directly into a printer's workflow environment using display screens that present information to the purchaser such that fewer display screens are needed for receiving and processing orders. This simplifies the order process. Moreover, order processing, typesetting, proofing, and imposition are automated. Orders may be received over the network from purchasers using Web browsers or through business-to-business (B2B) purchasing systems. The system improves order accuracy and corporate compliance, simplifies billing requirements, and tightens the overall delivery cycle.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 is a block diagram of a typical environment in which a printed material procurement system in accordance with the present invention may be practiced.

FIG. 2 illustrates a method for a purchaser or B2B purchaser of printed materials to accesses the procurement system and order printed materials.

FIGS. 3A-3G are illustrative web pages for display to a purchaser to retrieve information associated with the steps of FIG. 2.

FIG. 4 is a method for processing a printed material order for printing.

### DETAILED DESCRIPTION

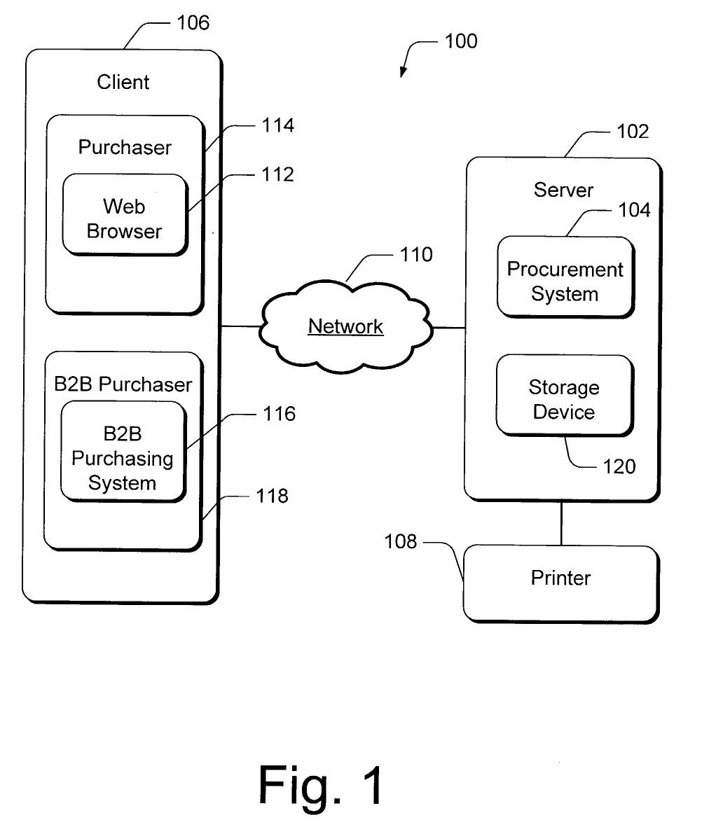

FIG. 1 depicts a typical environment 100 in which the present invention may be practiced. The environment 100 includes a server 102 housing a procurement system 104 for processing and fulfilling orders for printed materials, a client 106, a printer 108, and a network 110, e.g., the Internet. In a general overview, the client 106 orders printed materials by communicating over the network 110 with the procurement system 104 residing on the server 102. The procurement system 104 then fulfills the order by processing the order information for printing at the printer 108.

The client 106 is a conventional computing device. In a preferred embodiment, the client 106 supports a Web browser (browser) 112 that enables a purchaser 114 to accesses the procurement system 104 over the network 110 and/or supports a B2B purchasing system 116, such as Ariba, Clarus, Commerce One, or m\check{e}tiom, that enables a purchaser who uses the B2B purchasing system, i.e., a B2B purchaser 118, to access the procurement system 104. The browser 112 is a conventional Web browser. The client 106 may be essentially any processing device for presenting visual and/or audio content including, but not limited to, a desktop computer, laptop computer, handheld device, personal digital assistant (PDA), etc.

The server 102 is a conventional server computer that includes a Web server and an application server, which enable communications over the network 112 between the procurement system 104 and the Web browser 112 and/or the B2B purchasing system 116. The procurement system 104 is a computer software system that develops and serves information, such as HTML documents, for display at the client 106 and retrieves information from the client 106 that is related to ordering printed materials.

In a preferred embodiment, the computer software system is compatible with a plurality of B2B purchasing systems 116, such as Ariba, Clarus, Commerce One, and m\check{e}tiom. In addition, the computer software system is preferably capable of processing the order for printing. In the illustrated embodiment, the server 102 includes a conventional storage device 120 for storing information relating to the ordering of printed materials. In a preferred embodiment, the procurement system 104 is built upon Microsoft's Commerce Server and information management on the storage device 120 is implemented using Microsoft's SQL Server.

The printer 108 prints orders for printed materials processed by the procurement system 104. The printer 108 may be a conventional printer such as an Imagesetter printer or a digital image (DI) printer such as a Heidelburg printer. The printer 108 may support various printing techniques that include, but are not limited to, engraving, embossing, foil stamping, die cutting, sheet fed and web fed thermography, lithography, and holography. The printed materials may include by way of example, but are not limited to, stationery, business cards, envelopes, business forms, checks and security documents, Post-It-Notes®, and merchandising specialties.

Although shown in server 104, procurement system 104 can reside in other locations or as part of one or more applications, such as part of the operating system or independently as separate code on a computer-readable medium that executes in conjunction with a virtual object, hardware, and/or firmware device. In the exemplary implementation, procurement system 104 resides as a component in the form of computer-executable instructions and/or logic within a storage device accessible by a processor(s) operating on server 102, that when executed serves as a procurement system for server 102.

An implementation of exemplary subject matter using a procurement system 104 as described above may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, software, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

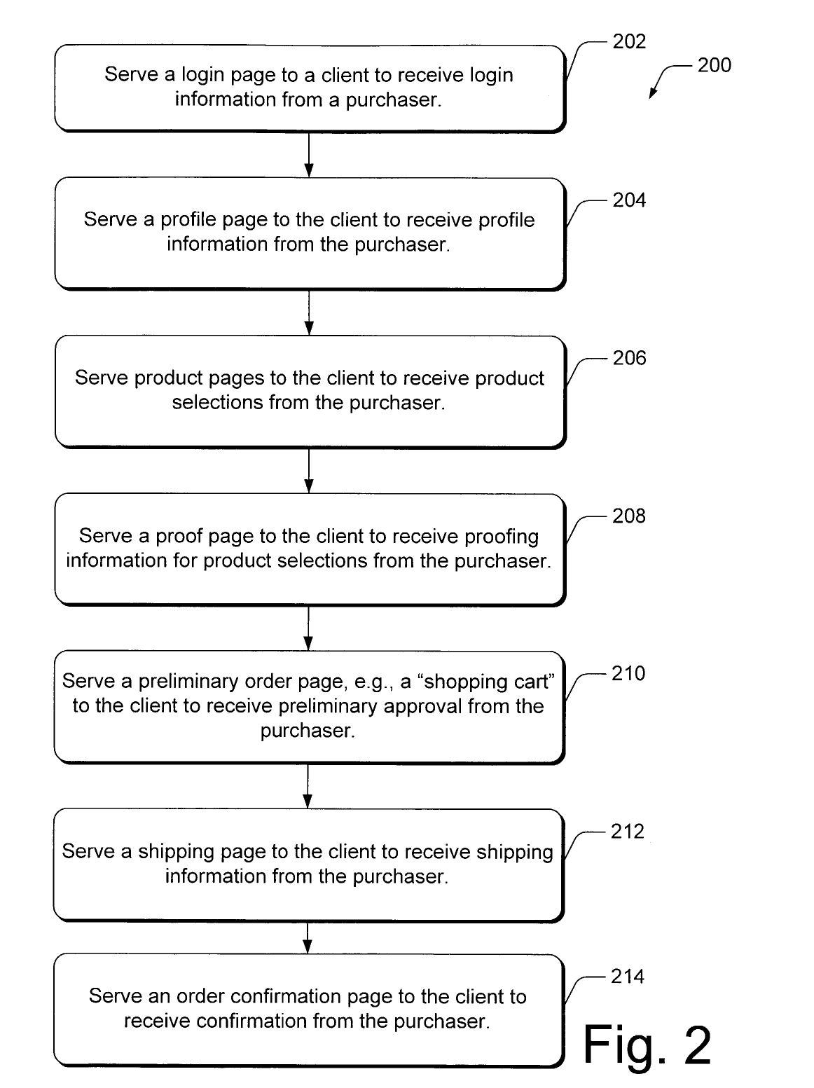

FIG. 2 illustrates a method 200 for a purchaser or B2B purchaser of printed materials to accesses the procurement system and order printed materials. Method 200 includes blocks 202 through 214. The order in which the method is described is not intended to be construed as a limitation. Furthermore, the method can be implemented by procurement system 104, but may also be implemented in any suitable hardware, software, firmware, or combination thereof.

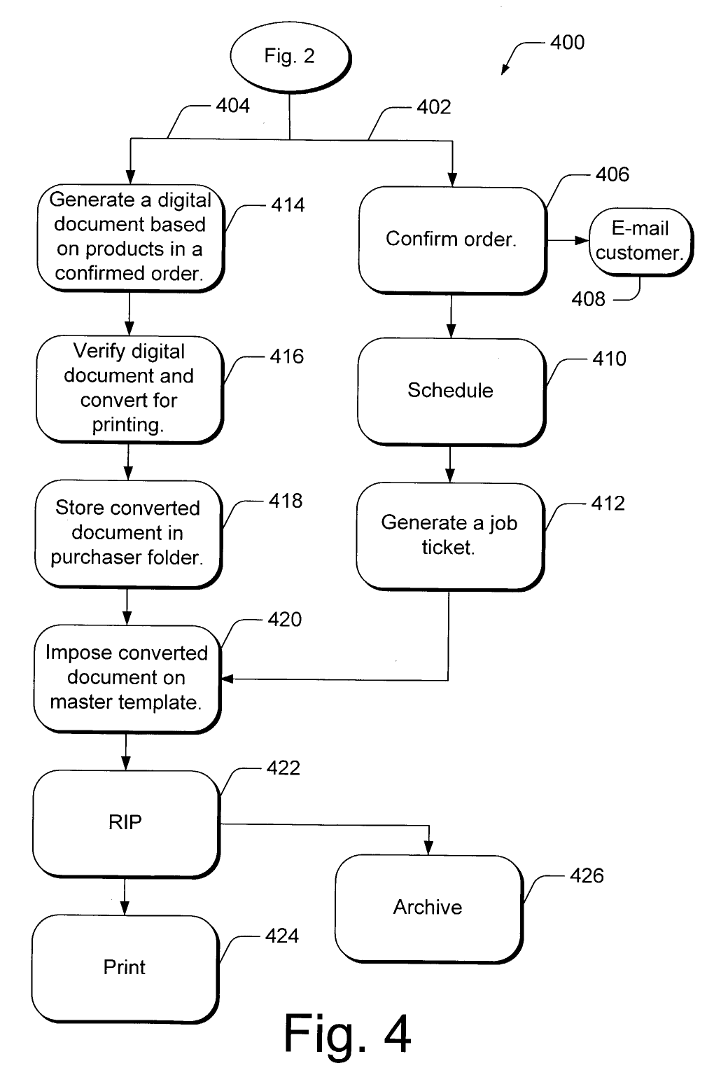

In a preferred use, the typical environment of FIG. 1 enables the preferred method 200 of FIG. 2 to be performed. Accessing the procurement system, the purchaser may enter an order, view an image of the printed materials ordered, and submit the order for processing through pages served (i.e., rendered by the server) to the client by the procurement system. The procurement system may then fulfill the order for printed materials as will be described in reference to FIG. 4 below.

At block 202, the procurement system serves a login page to a client to receive login information from a purchaser. At block 204, a profile page is served to the client to receive profile information from the purchaser. At block 206, display product pages are served to the client to receive product selections from the purchaser. At block 208, a proof page is served to the client to receive proofing information for product selections from the purchaser. At block 210, a preliminary order page is served to the client to receive preliminary approval from the purchaser. At block 212, a shipping page is served to the client to receive shipping information from the purchaser. At block 214, an order confirmation page is served to the client to receive order confirmation from the purchaser. The pages may be developed and served for viewing on a browser using conventional programming techniques including: caching, dynamic page development, vector graphics, etc.

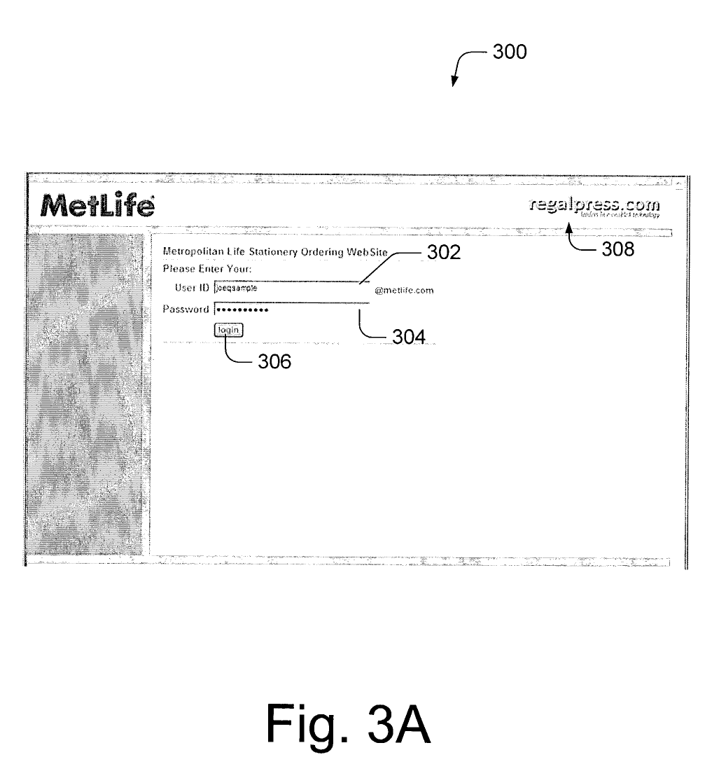

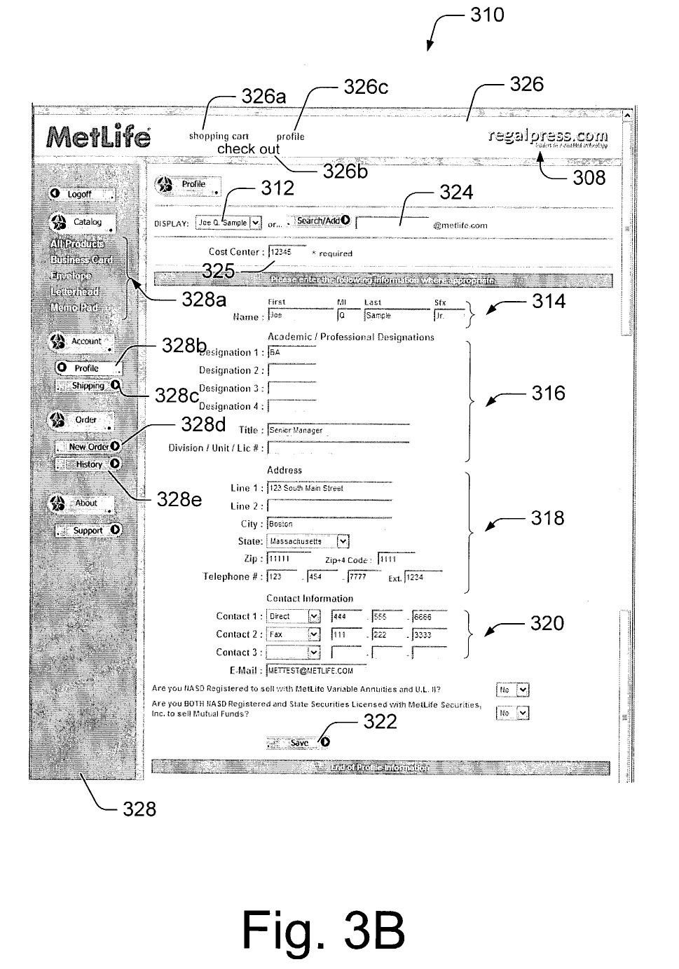

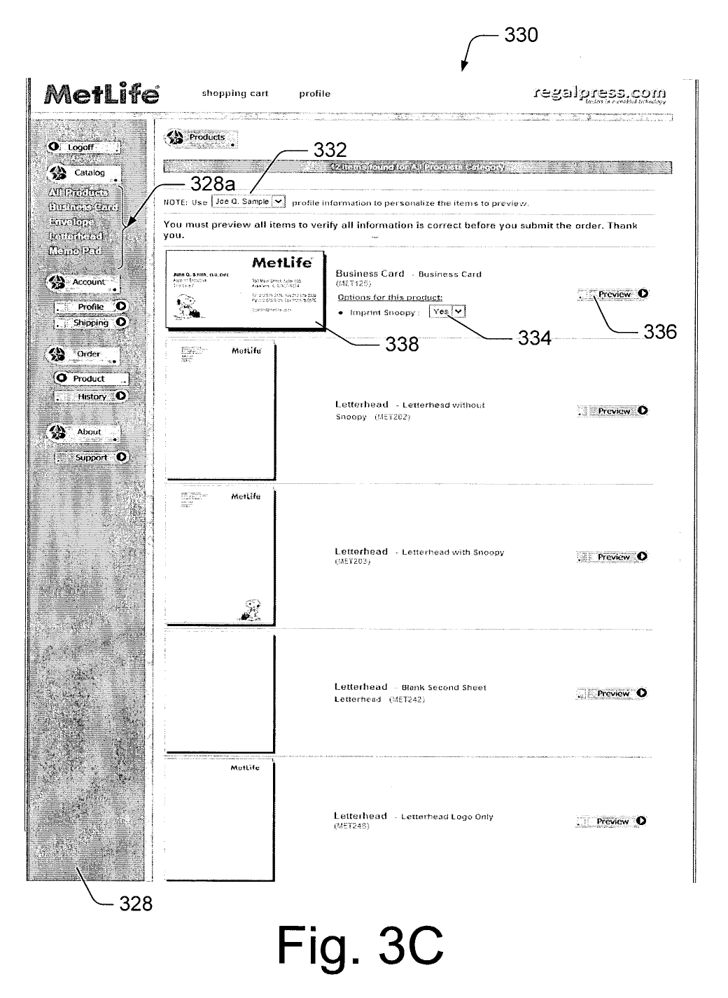

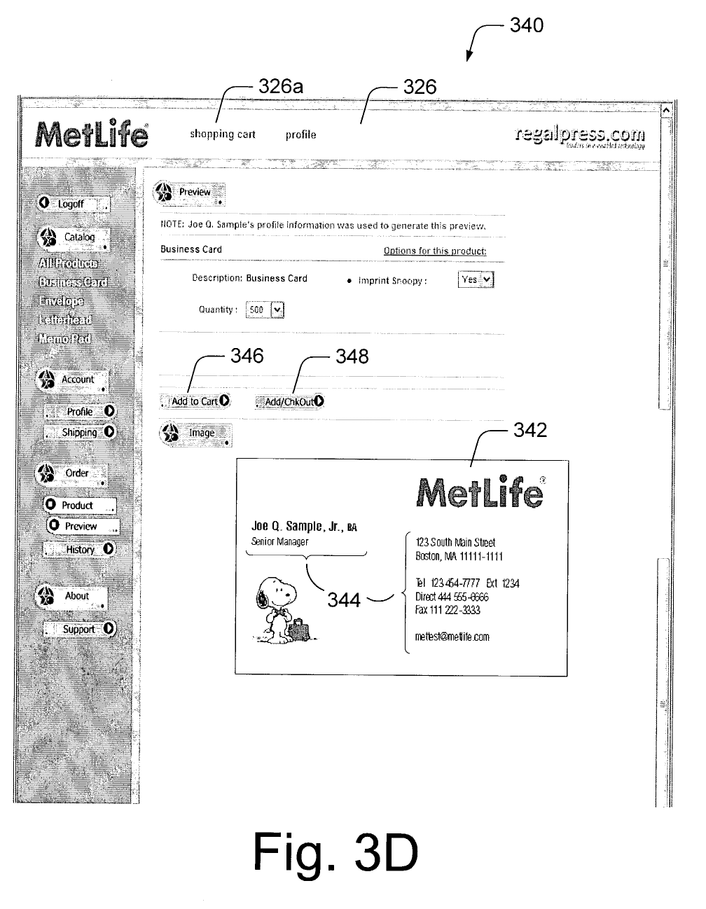

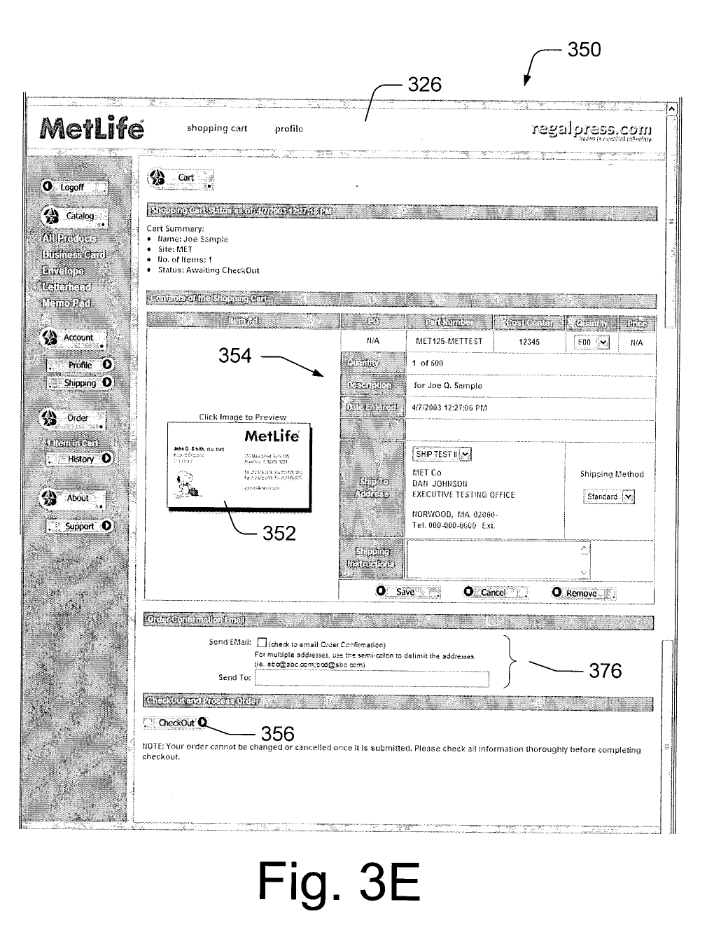

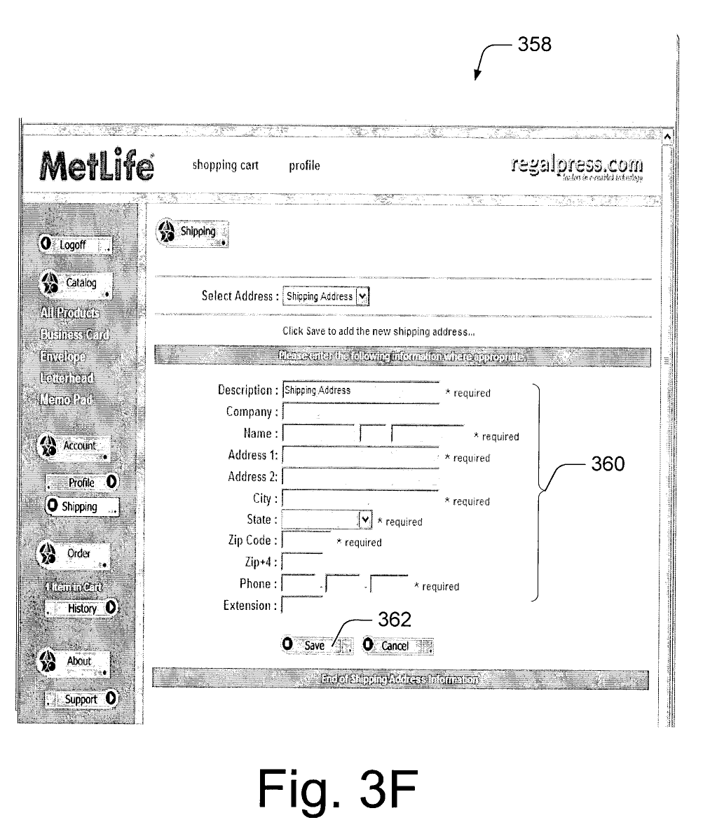

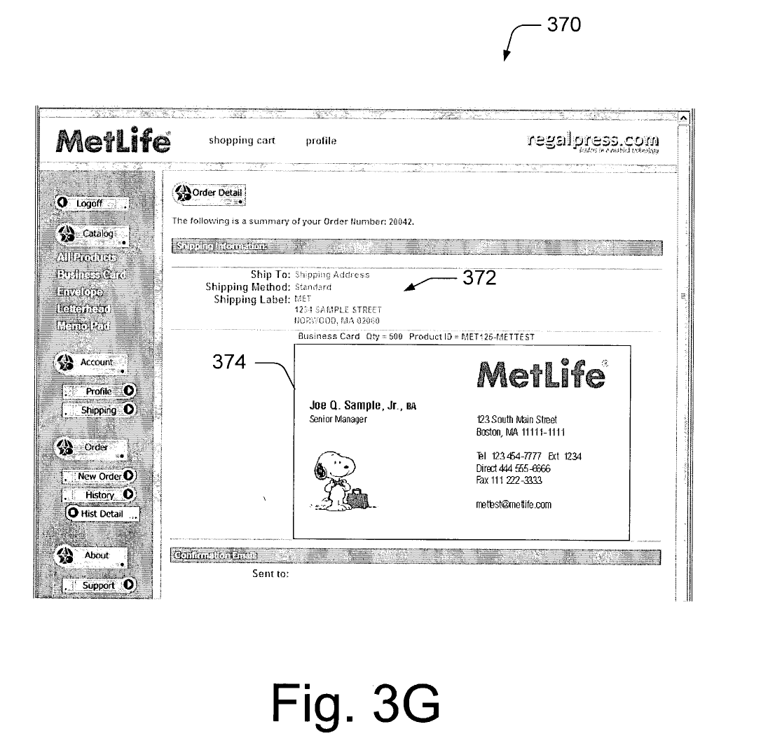

FIG. 3A depicts an illustrative login page 300 displayed on a browser at a client for a purchaser accessing the procurement system using a browser. The purchaser accesses the login page 300 by entering the universal resource locator (URL) of the procurement systems into an address field of the browser. The procurement system serves the login page to the client in response to the purchaser attempting to access the procurement system. In a preferred embodiment, login information including a user ID and an optional password are required to validate the purchaser for access to the procurement system. The login page 300 includes a User ID text entry box 302, a password text entry box 304, and a login button 306 for receiving the required login information. In addition, the login page 300 may contain additional textual information and/or graphics 308. Login information is preferably received from the purchaser by displaying the login page 300 on the purchaser's browser to solicit the login information, relying on the purchaser to enter the login information into the text entry fields 302 and 304, and processing the information entered into the text entry field 302 and 304 after the purchaser selects the login button 306 with a pointing device such as a mouse. If the purchaser is a B2B purchaser accessing the procurement system through a B2B purchasing system, the login procedure is invisible to the B2B purchaser and validation is done seamlessly using known message processing techniques.

FIG. 3B depicts an illustrative profile page 310 for displaying, adding, and selecting profile information. The profile information defines the imprint variables, such as name, title, address, and phone number, that will be imprinted on printed materials being ordered through the procurement system. The profile information is specific to an individual or group of individuals. In a preferred embodiment, each profile may be used for multiple ordered products and multiple profiles may be used for each order. Preferably, the profile is stored on a storage device for future or repeat orders.

The profile page 310 is displayed to the purchaser and the B2B purchaser after they are validated by the procurement system. In a preferred embodiment, after validation, the procurement system serves the profile page to the client. The profile page 310 includes a profile display box 312 which displays the name of an individual or group of individuals who's profile information is presently displayed. The profile display box 312 is preferably a drop down menu containing the names of other individuals or groups of individuals that may be selected for display of their profile information. The purchaser may select a profile for display from the drop down menu. In one embodiment, a profile indicator associated with a selected profile is generated by the procurement system when another page of the procurement system is requested, such as the product selection page (see FIG. 3C).

The profile information preferably consists of an individual's or group's name displayed in name text boxes 314 and the individual's or group's associated academic/professional title, address, and contact information that are displayed in academic/professional title text boxes 316, address text boxes 318, and contact information text boxes 320, respectively. An individual's or group of individual's profile data may be updated by entering information into the text boxes 314-320 and selecting the save button 322. Individuals may be added to the drop down menu associated with profile display box 312 by entering information in a search/add text entry box 324. If an entry is not found, an entry can be added using text boxes 314-320 in the same manner as profile information is updated. In the illustrated embodiment, a cost center text entry box 325 is provided for receiving cost center information.

The illustrative profile page 310, as well as most pages associated with the procurement system, further contains a header navigation bar 326 and a side navigation bar 328. The header navigation bar 326 contains selection text indicators, such as shopping cart 326a, check out 326b, and profile 326c, that can be selected by positioning a selection device over the text for accessing different pages. Selecting shopping cart 326a will access a shopping cart page (see FIG. 3E), selecting check out will access a shipping page (see FIG. 3F), and selecting profile 326c will access the profile page 310. The side navigation bar 328 contains selection text indicators such as product selection indicators 328a and selection buttons such as a profile button 328b, a shipping button 328c, a new order button 328d, and a history button 328e. Selecting the product selection indicators 328a will access product selection pages (see FIG. 3C), selecting the profile button 328b will access the profile page 310, selecting the shipping button 328c will access the shipping page (see FIG. 3G), selecting the new order button 328d will start a new order, and selecting the history box 328e will display a page listing past orders. In a preferred embodiment, the profile for an individual listed in the profile display text box 312 is selected when the name of the individual or group of individuals is listed in the profile display text box 312 and the purchaser selects a product selection indicator 328d.

It should noted that the “selection text indicators,” described herein, maybe implemented as “buttons,” and “buttons” described herein, may be implemented as “selection text indicators.” Moreover, selection text indicators or buttons may be implemented as any type of icon. For example, selection text indicators or buttons may be implemented as symbols with or without text. Also, selection text indicators or buttons may be implemented as a link to other Web pages or Internet sites.

Alternatively, profile information as well as information associated with a purchase for printed material can be received via electronic mail (e-mail) and parsed by procurement system 104. The parsing function involves identifying a user/customer, profile information (if any), and quantity and type of materials ordered (if any).

FIG. 3C depicts an illustrative product selection page 330 for displaying products at a client for selection by a purchaser. In a preferred embodiment, the procurement system serves product selection pages to the client when the product selection page 330 is requested, e.g., by selecting a product selection indicator 328a in the side navigation bar 328. The product selection page 330 includes a text box 332 which displays the individual or group of individuals who's profile was selected. In the illustrated embodiment, the text box 332 contains a drop down menu. In one embodiment, the individual or group of individuals may be changed, thereby changing the profile indicator, by selecting another individual or group of individuals from the drop down menu. The product selection text indicators 328a are used to control the products displayed on the product selection page 330. For example selecting “All Products” will display business cards, letter head, etc. On the other hand, selecting “Business Card” will display only business cards. In a preferred embodiment, images for each product are displayed on the product selection page 330. In the illustrated embodiment, special features may be specified. For example, whether a Snoopy™ character is displayed on a business card 338 is indicated by selecting yes/no from an Imprint Snoopy selection box 334. In the illustrated web page 330, a product is selected by selecting a preview button associated with the product, such as the preview button 336 associated with the business card 338. When a product is selected by the purchaser, a product selection indicator is generated at the procurement system. In one embodiment, the product selection indicator is generated and transferred to the procurement system in response to the selection of a preview button associated with a selected product, such as the preview button 336 associated with the business card 338.

FIG. 3D depicts an illustrative proofing page 340. In a preferred embodiment, the procurement system serves the proofing page to the client in response to receiving a product selection indicator, e.g., in response to the selection of a preview button 336 (FIG. 3C) associated with the product. The proofing page 340 depicts a graphical image of the product to be proofed that contains applicable profile information for a selected profile, such as the graphical image 342 for a business card 338 containing profile information 344. This allows the actual product containing profile information to be displayed over the network, i.e., on-line, for proofing prior to ordering. In one embodiment, the graphical image 342 is a conventional graphics file such as a GIF or jpg file. In an alternative embodiment, the graphical image 342 is created using vector graphics, which allow the graphical image 342 to appear exactly as it will appear when printed and further allows the graphical image to be resized. The depicted product may be selected for ordering by selecting the add to cart indicator 346 or the add/check out indicator 348. Selecting the add to cart indicator 346 will retain the order information and display the product selection page 330 (FIG. 3C) for selection of another product. Selecting the add/check out indicator 348 will access a preliminary order information page, i.e., a “shopping cart” (see FIG. 3E). In a preferred embodiment, when a product is ordered by the purchaser, a product order indicator associated with the selected product is generated by the procurement system. In one embodiment, the product order indicator is generated at the procurement system in response to the selection of an add to cart or add/check indicator such as the add to cart indicator 346 or the add/check out indicator 348.

FIG. 3E depicts an illustrative preliminary order page 350, i.e., a “shopping cart,” for displaying ordered products. In a preferred embodiment, the procurement system serves the preliminary order page 350 to the client in response to selecting the shopping cart indicator 326a in the header navigator bar 326 associated with the procurement system. For each ordered product, the web page 350 displays a graphical image 352 of the product containing profile imprint information and additional ordering information 354 such as quantity, description, and part number. By selecting the graphical image 352 with a selection device such as a mouse, the graphical image 342 (FIG. 3D) used for proofing will be displayed. The products listed on the preliminary web page are approved by the purchaser by selecting the checkout button 356, which will access a shipping web page (see FIG. 3F). The preliminary order page 350 provides a centralized location for quickly and easily viewing the order in detail, including the information that will actually be printed on the printed materials.

In addition, the order page 350 includes an e-mail information area 376 for selecting an e-mail address or entering an e-mail address to be used for purchaser confirmation purposes.

FIG. 3F depicts an illustrative shipping page 358 for receiving ship-to information from the purchaser. In a preferred embodiment, the procurement system serves the shipping page to the client in response to the purchaser selecting a checkout button 356 (FIG. 3E). The purchaser enters ship-to information, which is preferably saved on a storage device for future use. The shipping page 358 contains shipping information text entry boxes 360 for receiving ship-to information such as address, city, state, and zip code. The ship-to information is selected and saved by selecting the save indicator 362.

FIG. 3G depicts a confirmation page 370 for receiving confirmation information from the purchaser related to ordered printed materials. In a preferred embodiment, the procurement system serves the confirmation page to the client in response to selecting the save indicator 362 (FIG. 3F) on the shipping page 358. In the illustrated embodiment, the confirmation page 370 includes shipping information 372 and ordered product information 374. In certain embodiments, if the purchaser is a B2B purchaser, when the B2B purchaser selects the confirm indicator on the confirmation page, information will be transferred to a B2B purchasing system to retrieve necessary approvals. In the B2B environment, the ordered printed materials are not confirmed until a predefined approval indicator is received at the procurement system from the B2B purchasing system.

FIG. 4 is a method 400 for processing a printed material order for printing. Method 400 includes blocks 406 through 426. The order in which the method is described is not intended to be construed as a limitation. Furthermore, the method can be implemented by procurement system 104, but may also be implemented in any suitable hardware, software, firmware, or combination thereof.

After the order for printed materials is confirmed, confirmation is sent to the purchaser, the order is scheduled, and the order is prepared for printing. Customer confirmation and scheduling are performed separately from the preparation of the order for printing as indicated by the first path 402 for customer confirmation and scheduling and the second path 404 for order printing preparation.

In the first path 402, confirmation of the order is sent to the purchaser and the order is scheduled. The customer confirmation at block 406 includes the generation of a paper copy to be sent to the purchaser and may include the generation of an e-mail to be sent to the purchaser at block 408. At block 410, the order is scheduled. The scheduling includes allocating resource to the order and interfacing with an accounting module. At block 412, a job ticket is generated that groups orders and assigns the grouped orders to a printer for printing. In a preferred embodiment, the procurement systems generates the job ticket.

In the second path 404, the order is prepared for printing. At block 414, a digital document such as a PDF file is generated. The digital document is an image of the information that will be printed on a product within the order. In one embodiment, imprint information from the order is systematically merged with predefined templates of the ordered item to produce the digital document.

At block 416, the digital document is verified and converted for printing. In a preferred embodiment, the digital document is verified for inconsistencies. In addition, the colors are converted from Web RGB to specific Pantone or Process Color color formats for printing. Also, fonts are imbedded and optimized for print quality. The verified and converted digital document is then stored in a specific customer folder on a storage device at block 418.

At block 420, the first and second paths 402, 404 are combined to impose the verified and converted digital document onto a master template. In a preferred embodiment, the converted digital documents are imposed on the master template by product type and quantity.

At blocks 422 and 424, the converted document is RIP processed and printed, respectively. At block 422, the imposition performed at 420 is verified and checked for specific processing requirements. If the converted document is to be printed on a digital imaging (DI) printer (e.g., a Heidelburg DI printer), the converted document is passed to the DI printer for printing. On the other hand, if the converted document is to be printed on a non-DI printer (e.g., an Imagesetter), the converted document is further converted to a non-DI compatible format such as PostScript. In addition, processing may be performed to separate colors for printing. For example, if the printer prints one color at a time and a business card with two colors (e.g., black and blue) is to be printed, the black portions are separated from the blue portions to create two separate films that are used by the printer in two steps to deliver a business card having two colors.

At block 426, the converted document is archived on a storage device for use at a later date. The archived document may be used for future product orders and for reprinting products that were incomplete due to mechanical failures.

Besides using a web browser as a basis to submit print orders as described above, it is also possible for procurement system 104 to receive email message order from purchaser 114 and/or B2B purchaser 118. The e-mail message can then be parsed for information to determine the order, such as, but not limited to, indicating product information to be ordered, quantity of printed material, shipping address, account information, and so forth.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A print material procurement system comprising software configured to: receive profile information from a particular customer and responsive to the profile information and without any user intervention, automatically: serve, to a client computer, a Web browser page with a graphical image of printed material particularly associated with the customer, the Web browser page containing icons permitting a user of the client computer to view, proof and/or order one or more types of printed material with one or more portions of the profile information displayed as part of the graphical image of the printed material.

2. The procurement system as recited in claim 1, wherein the icons are located on a navigation bar of the Web browser page.

3. The procurement system as recited in claim 1, wherein the icons are located on a navigation bar of the Web browser page, the icons including product selection indicators that when selected by a user of the client computer cause one or more product selection Web browser pages to be served to the client computer.

4. The procurement system as recited in claim 1, wherein the icons are located on a navigation bar of the Web browser page, the icons including a profile selection indicator that when selected by a user of the client computer cause one or more profile Web browser pages to be served to the client computer.

5. The procurement system as recited in claim 1, wherein the icons are located on a navigation bar of the Web browser page, the icons including a shipping selection indicator that when selected by a user of the client computer cause one or more shipping Web browser pages to be served to the client computer.

6. The procurement system as recited in claim 1, wherein the icons are located on a navigation bar of the Web browser page include a history button that when selected by a user of the client computer cause one or more Web browser pages to be served to the client computer showing previous ordering activity associated with the customer.

7. One or more computer-readable media having computer readable instructions thereon which, when executed by a computer, cause the computer to: receive profile information from a particular customer and responsive to the profile information and without any user intervention, automatically: serve, to a client computer, a Web browser page with a graphical image of printed material particularly associated with the customer, the web browser page containing icons permitting a user of the client computer to view, proof and/or order one or more types of printed material with one or more portions of the profile information displayed as part of the graphical image of the printed material.

8. One or more computer-readable media as recited in claim 7, further comprising computer executable instructions that, when executed, direct the computer to send a confirmation e-mail message to the client computer confirming an order upon receiving a message from the client computer that an order is complete.

9. One or more computer-readable media as recited in claim 7, wherein the icons are located on a navigation bar of the Web browser page.

10. In a Web based system having a client and a server, the client having a browser, a method for a purchaser to order printed material via the browser, comprising:
rendering, at the client, a profile page for entering profile information about the purchaser;
receiving the profile information at the server;
rendering, at the client, a product page for entering a product selection from the purchaser in response to receiving the profile information, the product page containing a graphical image of one or more products to select with the profile information;
receiving the product selection at the server;
rendering, at the client, a proof page for entering proofing information regarding the product selection and/or profile information, in response to the product selection from the purchaser;
receiving the proofing information at the server;
rendering, at the client, a shipping page for entering shipping information;
receiving the shipping information at the server; and
fulfilling the order.

11. The method as recited in claim 10, further comprising rendering, at the client, a confirmation page indicating confirmation information about the order.

12. The method as recited in claim 10, further comprising e-mailing the purchaser a confirmation of the order.

13. The method as recited in claim 1, further comprising rendering, at the client, a login page to receive login information from the purchaser.

14. One or more computer-readable media having computer readable instructions thereon which, when executed by a server, cause the server to:
render, at a client, a profile page for entering profile information about a purchaser;
receive the profile information at the server;
render, at the client, a product page for entering a product selection from the purchaser in response to receiving the profile information, the product page containing a graphical image of one or more products to select with the profile information;
receive the product selection at the server;
render, at the client, a proof page for entering proofing information regarding the product selection and/or profile information, in response to the product selection from the purchaser;
receive the proofing information at the server;
render, at the client, a shipping page for entering shipping information; and
receive the shipping information at the server.

15. A printed materials procurement method, said method comprising the steps of:
serving a login page to a client to receive login information from a purchaser;
serving a profile page to the client to receive profile information from the purchaser;
serving product pages to the client to receive product selections from the purchaser;
serving a proof page to the client to receive proofing information for product selections from the purchaser;
serving a preliminary order page to the client to receive preliminary approval from the purchaser, said preliminary order page comprising at least a first display area for displaying a first graphical image corresponding to a first product selection and a second display area for displaying a second graphical image corresponding to a second product selection, said first and second graphical images displaying images of the selected products with appropriate profile information;
serving a shipping page to the client to receive shipping information from the purchaser;
serving an order confirmation page to the client to receive order confirmation from the purchaser; and
fulfilling confirmed orders.

16. The method as recited in claim 15, further comprising sending an e-mail confirming the orders.

17. A method of organizing visual content for a customer experience while visiting a Web site for purchasing printed materials, the method comprising:
providing a login page to enter the Web site; and
providing a profile page containing icons permitting a user of the client computer to enter profile information and navigate to one or more other pages for viewing, proofing, shipping and/or ordering one or more types of printed material, the one or more other pages containing at least one graphical image of the printed material with one or more portions of the profile information displayed as part of the graphical image, the profile information particularly associated with a particular customer.

18. The method as recited in claim 17, wherein the icons are located on a navigation bar.

19. The method as recited in claim 17, wherein the organizing further comprises rendering a confirmation page to the user of the client computer providing confirmation information related to an order associated with the printed material.
